(19) United States
(12) Patent Application Publication
(10) Pub. No.: US 2017/0353738 A1
(43) Pub. Date: Dec. 7, 2017

(54) METHOD FOR DETERMINING STORAGE POSITION OF COEFFICIENT ACCORDING TO TRANSPOSE FLAG BEFORE COEFFICIENT IS STORED INTO INVERSE SCAN STORAGE DEVICE AND ASSOCIATED APPARATUS AND MACHINE READABLE MEDIUM

(71) Applicant: MEDIATEK INC., Hsin-Chu (TW)

(72) Inventors: Min-Hao Chiu, Hsinchu City (TW); Yung-Chang Chang, New Taipei City (TW)

(21) Appl. No.: 15/615,845

(22) Filed: Jun. 7, 2017

Related U.S. Application Data
(60) Provisional application No. 62/346,596, filed on Jun. 7, 2016.

(51) Int. Cl. H04N 19/88; H04N 19/436; H04N 19/91; H04N 19/82

(52) U.S. Cl. CPC H04N 19/88; H04N 19/91; H04N 19/436; H04N 19/82

(57) ABSTRACT

A coefficient access method includes: receiving a coefficient generated from an entropy decoding process, wherein the received coefficient is a part of a transform block (TB); before the received coefficient is stored into an inverse scan (IS) storage device, determining a storage position of the received coefficient according to a transpose flag associated with the TB, wherein the transpose flag indicates whether or not a coefficient transpose process is needed; and after the storage position is determined, storing the received coefficient into the determined storage position in the IS storage device.

### CROSS REFERENCE TO RELATED APPLICATIONS

This application claims the benefit of U.S. provisional application No. 62/346,596, filed on Jun. 7, 2016 and incorporated herein by reference.

### BACKGROUND

The present invention relates to an inverse scan design, and more particularly, to a method for determining a storage position of a coefficient according to a transpose flag before the coefficient is stored into an inverse scan storage device and associated apparatus and machine readable medium.

The conventional video coding standards generally adopt a block based coding technique to exploit spatial and temporal redundancy. For example, the basic approach is to divide the whole source frame into a plurality of blocks, perform intra prediction/inter prediction on each block, transform residues of each block, and perform quantization, scan and entropy encoding. Besides, a reconstructed frame is generated in a coding loop to provide reference pixel data used for coding following blocks. For certain video coding standards, in-loop filter(s) may be used for enhancing the image quality of the reconstructed frame.

A video decoder is used to perform an inverse operation of a video encoding operation performed by a video encoder. For example, inverse scan (IS) is used to store coefficients generated from an entropy decoder, and output stored coefficients in a scan/readout order for following inverse quantization (IQ). However, it is possible that inverse quantization of different transform blocks may require different scan/readout orders of coefficients. For example, inverse quantization of a first transform block may require a non-transposed scan/readout order of coefficients of the first transform block, while inverse quantization of a second transform block may require a transposed scan/readout order of coefficients of the second transform block. Using multiple IS storage devices for supporting different scan/readout orders of coefficients under a designed throughput requirement of inverse quantization is not a cost-efficient solution. Hence, there is a need for a high performance and low cost inverse scan design.

### SUMMARY

One of the objectives of the claimed invention is to provide a method for determining a storage position of a coefficient according to a transpose flag before the coefficient is stored into an inverse scan storage device and associated apparatus and machine readable medium.

According to a first aspect of the present invention, an exemplary coefficient access method is disclosed. The exemplary coefficient access method includes: receiving a coefficient generated from an entropy decoding process, wherein the received coefficient is a part of a transform block (TB); before the received coefficient is stored into an inverse scan (IS) storage device, determining a storage position of the received coefficient according to a transpose flag associated with the TB, wherein the transpose flag indicates whether or not a coefficient transpose process is needed; and after the storage position is determined, storing the received coefficient into the determined storage position in the IS storage device.

According to a second aspect of the present invention, an exemplary coefficient access apparatus is disclosed. The exemplary coefficient access apparatus includes a receiving circuit, a write control circuit, and a write circuit. The receiving circuit is arranged to receive a coefficient generated from an entropy decoder, wherein the received coefficient is a part of a transform block (TB). The write control circuit is arranged to determine a storage position of the received coefficient according to a transpose flag associated with the TB before the received coefficient is stored into an inverse scan (IS) storage device, wherein the transpose flag indicates whether or not a coefficient transpose process is needed. The write circuit is arranged to store the received coefficient into the determined storage position in the IS storage device after the storage position is determined by the write control circuit.

According to a third aspect of the present invention, an exemplary non-transitory machine readable medium is disclosed. The exemplary non-transitory machine readable medium has a program code stored therein. When executed by a processor, the program code instructs the processor to perform following steps: receiving a coefficient generated from an entropy decoding process, wherein the received coefficient is a part of a transform block (TB); before the received coefficient is stored into an inverse scan (IS) storage device, determining a storage position of the received coefficient according to a transpose flag associated with the TB, wherein the transpose flag indicates whether or not a coefficient transpose process is needed; and after the storage position is determined, storing the received coefficient into the determined storage position in the IS storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video decoder using a proposed coefficient transpose design according to an embodiment of the present invention.

FIG. 2 is a diagram illustrating an inverse scan circuit according to an embodiment of the present invention.

FIG. 3 is a flowchart illustrating a method for controlling and performing a coefficient transpose process according to an embodiment of the present invention.

FIG. 4 is a diagram illustrating a first transpose process (e.g., internal 4×4 CG transpose process) TP1 applied to one 4×4 CG according to an embodiment of the present invention.

FIG. 5 is a diagram illustrating a first transpose process (e.g., internal 4×4 CG transpose process) TP1 applied to different 4×4 CGs in the same 8×8 TB according to an embodiment of the present invention.

FIG. 6 is a diagram illustrating a second transpose process (e.g., external 4×4 CG transpose process) TP2 applied to 4×4 CGs of one 8×8 TB according to an embodiment of the present invention.

FIG. 7 is a diagram illustrating a second transpose process (e.g., external 4×4 CG transpose process) TP2 applied to different 4×4 CGs in the same 8×8 TB according to an embodiment of the present invention.

FIG. 8 is a diagram illustrating two coefficient input scenarios of inverse quantization according to an embodiment of the present invention.

FIG. 9 is a diagram illustrating a first footprint of an IS storage device according to an embodiment of the present invention.

FIG. 10 is a diagram illustrating a second footprint of an IS storage device according to an embodiment of the present invention.

FIG. 11 is a diagram illustrating a third footprint of an IS storage device according to an embodiment of the present invention.

FIG. 12 is a diagram illustrating a modified second footprint of an IS storage device according to an embodiment of the present invention.

FIG. 13 is a diagram illustrating a modified third footprint of an IS storage device according to an embodiment of the present invention.

FIG. 14 is a diagram illustrating an inverse scan design with software-based coefficient access control according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

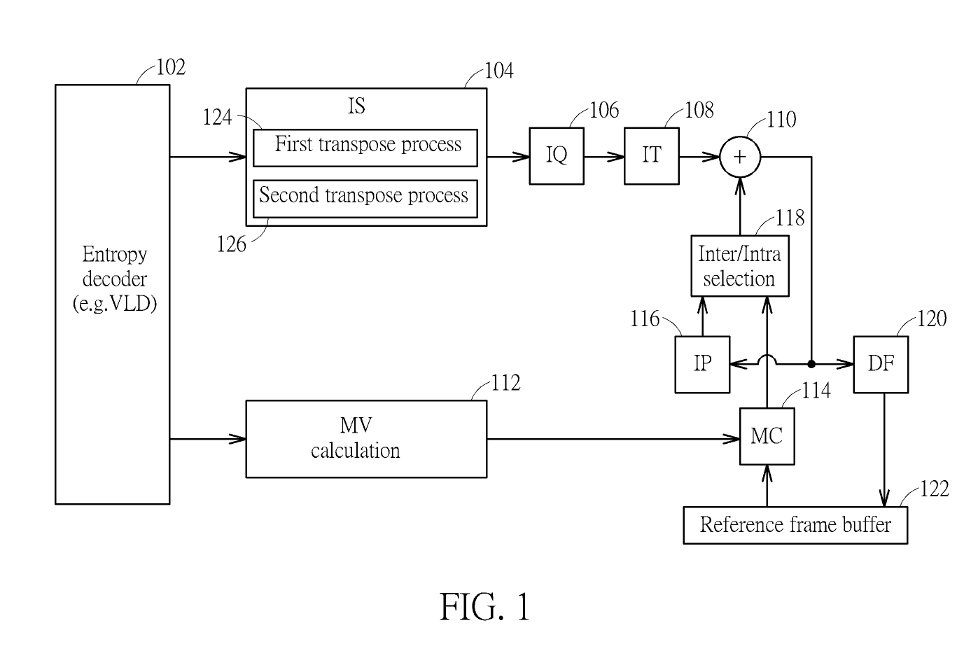

FIG. 1 is a diagram illustrating a video decoder using a proposed coefficient transpose design according to an embodiment of the present invention. As shown in FIG. 1, the video decoder 100 includes an entropy decoder (e.g., a variable length decoder (VLD)) 102, an inverse scan circuit (denoted by “IS”) 104, an inverse quantization circuit (denoted by “IQ”) 106, an inverse transform circuit (denoted by “IT”) 108, a reconstruction circuit 110, a motion vector calculation circuit (denoted by “MV calculation”) 112, a motion compensation circuit (denoted by “MC”) 114, an intra prediction circuit (denoted by “IP”) 116, an inter/intra mode selection circuit (denoted by “Inter/intra selection”) 118, an in-loop filter (e.g., a deblocking filter (DF) 120), and a reference frame buffer 122. When a block is inter-coded, the motion vector calculation circuit 112 refers to information parsed from an encoded bitstream by the entropy decoder (e.g., VLD) 102 to determine a motion vector between the block of a current frame being decoded and a prediction block of a reference frame that is a reconstructed frame and stored in the reference frame buffer 122. When a block is intra-coded, the intra prediction circuit 116 determines a prediction block from the current frame which includes the block.

The decoded residual of the block is obtained by the reconstruction circuit 110 through the entropy decoder (e.g., VLD) 102, the inverse scan circuit 104, the inverse quantization circuit 106, and the inverse transform circuit 108. The inter/intra mode selection circuit 118 outputs the intra-predicted block to the reconstruction circuit 110 when the block is intra-coded, and outputs the inter-predicted block to the reconstruction circuit 110 when the block is inter-coded. The reconstruction circuit 110 combines the decoded residual and the prediction block to generate a reconstructed block. The reconstructed block is processed by the deblocking filter 120 and then stored into the reference frame buffer to be a part of a reference frame that may be used for decoding following frames.

In this embodiment, the inverse scan circuit 104 supports different scan/readout orders of coefficients for the following inverse quantization circuit 106. For example, when a transposed scan/readout order of coefficients is required by the following inverse quantization circuit 106, the inverse scan circuit 104 performs a coefficient transpose process, including a first transpose process 124 and a second transpose process 126, to store coefficients (particularly, quantized transform coefficients) directly obtained from the preceding entropy decoder (e.g., VLD) 102 into storage positions determined based on a result of the coefficient transpose process. For another example, when a non-transposed scan/readout order of coefficients is required by the following inverse quantization circuit 106, the inverse scan circuit 104 bypasses the coefficient transpose process, and stores coefficients (particularly, quantized transform coefficients) directly obtained from the preceding entropy decoder (e.g., VLD) 102 into storage positions determined based on related information given from the entropy decoder (e.g., VLD) 102.

In one exemplary design, the video decoder 100 may be a second generation Audio Video Coding Standard (AVS2) decoder. Hence, the inverse scan circuit 104 supports a non-transposed scan/readout order of coefficients and a transposed scan/readout order of coefficients that may be required by the AVS2 IQ process. However, this is for illustrative purposes only, and is not meant to be a limitation of the present invention. In practice, the proposed coefficient transpose design may be employed by any video decoder design that uses inverse scan to provide coefficients to a following processing stage (e.g., inverse quantization).

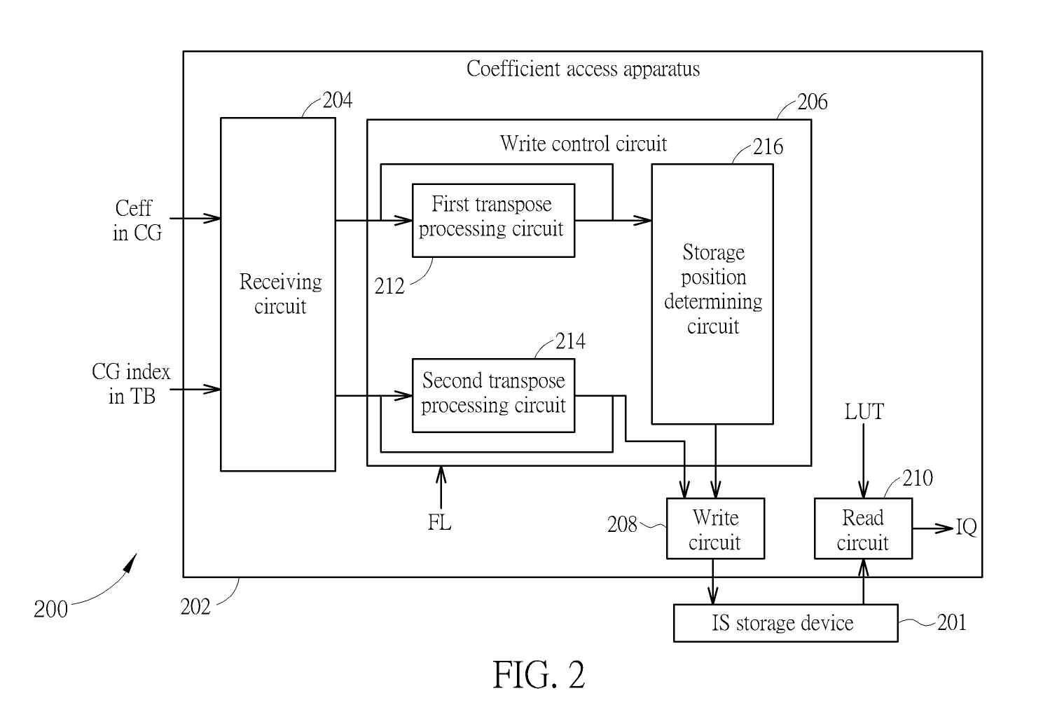

FIG. 2 is a diagram illustrating an inverse scan circuit according to an embodiment of the present invention. The inverse scan circuit 104 shown in FIG. 1 may be implemented using the inverse scan circuit 200 shown in FIG. 2. As shown in FIG. 2, the inverse scan circuit 200 includes an inverse scan (IS) storage device 201 and a coefficient access apparatus 202. For example, the IS storage device 201 may be implemented using a static random access memory (SRAM), a dynamic random access memory (DRAM), or registers. The coefficient access apparatus 202 includes a receiving circuit 204, a write control circuit 206, a write circuit 208, and a read circuit 210.

The receiving circuit 204 is coupled to an entropy decoder (e.g., entropy decoder 102 shown in FIG. 1), and is arranged to receive coefficients C_{eff} in one coding group (CG) and associated CG position information (e.g., a CG index in a transform block (TB)) from the entropy decoder. For example, one 8×8 TB may be partitioned into four 4×4 CGs, such that one 4×4 CG may include 16 coefficients C_{eff}. When one coefficient C_{eff} in a 4×4 CG is generated from the entropy decoder to the coefficient access apparatus 202, a CG index of the 4×4 CG is also generated from the entropy decoder to the coefficient access apparatus 202. The coefficient C_{eff} (which has a coefficient index) in a CG and a CG index of the CG can be used to determine a coefficient storage position in the IS storage device 201 and a CG position, directly or indirectly.

The write control circuit 206 includes a first transpose processing circuit 212, a second transpose processing circuit 214, and a storage position determining circuit 216. The first transpose processing circuit 212 is arranged to perform the first transpose process 124 shown in FIG. 1. The second transpose processing circuit 214 is arranged to perform the second transpose process 126 shown in FIG. 1. In a case where one 8×8 TB is partitioned into four 4×4 CGs, the first transpose process 124 may be an internal 4×4 CG transpose process, and the second transpose process 126 may be an external 4×4 CG transpose process. It should be noted that the size of one TB and the size of one CG can be adjusted, depending upon the actual design considerations. That is, the size of one TB is not limited to 8×8, and/or the size of one CG is not limited to 4×4. The proposed coefficient transpose process has no limitations on the TB size and/or the CG size. Further details of the first transpose process (e.g., internal CG transpose process) 124 and the second transpose process (e.g., external CG transpose process) 126 are described later.

The storage position determining circuit 216 is arranged to determine a storage position of each coefficient in each CG of a TB. When a coefficient transpose process is needed, the storage position determining circuit 216 refers to an output of the first transpose processing circuit 212 to determine a storage position of a coefficient received by the receiving circuit 204, where the output of the first transpose processing circuit 212 indicates a transposed coefficient position in a CG, and the output of the second transpose processing circuit 214 indicates a transposed CG position in a TB. When the coefficient transpose process is not needed, the storage position determining circuit 216 refers to information given from the entropy decoder to determine the storage position of the coefficient received by the receiving circuit 204, where the coefficient in a CG is indicative of a non-transposed coefficient position in the CG, and the CG index in a TB is indicative of a non-transposed CG position in the TB. In this embodiment, after the receiving circuit 204 receives a coefficient C_{eff} (which is a part of a TB) from the entropy decoder (e.g., entropy decoder 102 shown in FIG. 1), the write control circuit 206 is arranged to determine a storage position of the received coefficient C_{eff} according to the transpose flag FL associated with the TB before the received coefficient C_{eff} is stored into the IS storage device 201 via the write circuit 208, where the transpose flag FL indicates whether or not the coefficient transpose process is needed.

In this embodiment, bypassing of the first transpose processing circuit 212 and the second transpose processing circuit 214 is controlled according to the transpose flag FL. In one exemplary design, the entropy decoder (e.g., entropy decoder 102 shown in FIG. 1) may refer to information parsed from a bitstream (which also includes entropy encoded coefficients) to set the transpose flag FL, and may transmit the transpose flag FL to the write control circuit 206 via the receiving circuit 204. In another exemplary design, the entropy decoder (e.g., entropy decoder 102 shown in FIG. 1) may transmit information parsed from a bitstream (which also includes entropy encoded coefficients) to the write control circuit 206 via the receiving circuit 204, and the write control circuit 206 may refer to the received information to set the transpose flag FL.

Suppose that the inverse scan circuit 200 is a part of an AVS2 decoder. In accordance with the AVS2 specification, when IntraModeldx=1 and IsChroma=0, if the coding unit type=‘I_2N’ or ‘I_N’, then QuantCoeffMatrix transpose process (e.g., transposing the value of QuantCoeffMatrix[i] [j] and QuantCoeffMatrix[j] [i], where i=0˜(M₁−1), j=0˜(M₂−1), M₁ is a width of the coefficient matrix QuantCoeffMatrix, and M₂ is a height of the coefficient matrix QuantCoeffMatrix) is implemented; otherwise, QuantCoeffMatrix transpose process is not implemented. When the QuantCoeffMatrix transpose process is implemented, a transposed scan/readout order is used to provide coefficients from the inverse scan circuit 200 to an inverse quantization circuit (e.g., inverse quantization circuit 106 shown in FIG. 1). Hence, the transpose flag FL may be set by a first value indicating that a coefficient transpose process is needed. However, when the QuantCoeffMatrix transpose process is not implemented, a non-transposed scan/readout order is used to provide coefficients from the inverse scan circuit 200 to an inverse quantization circuit (e.g., inverse quantization circuit 106 shown in FIG. 1). Hence, the transpose flag FL may be set by a second value indicating that a coefficient transpose process is not needed. The above is for illustrative purposes only, and is not meant to be a limitation of the present invention. When the inverse scan circuit 200 is employed by a video decoder complying with a different video coding standard, the transpose flag FL may be set by using a different rule.

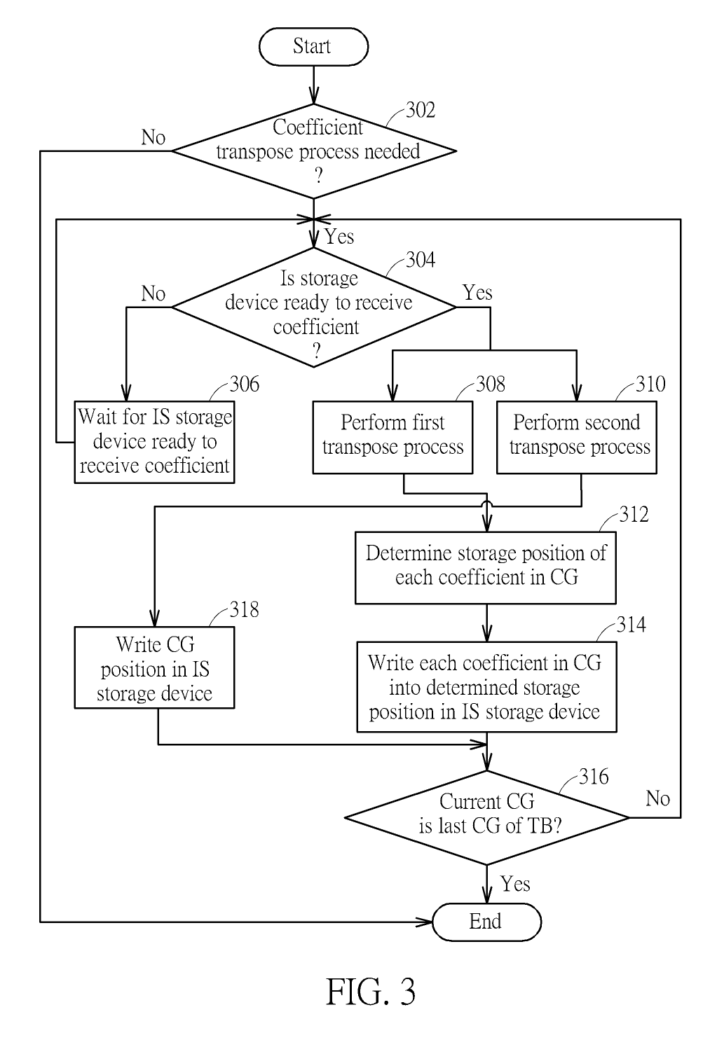

Please refer to FIG. 3 in conjunction with FIG. 2. FIG. 3 is a flowchart illustrating a method for controlling and performing a coefficient transpose process according to an embodiment of the present invention. The method shown in FIG. 3 may be employed by the coefficient access apparatus 202 shown in FIG. 2. At step 302, the write control circuit 206 checks the transpose flag FL to determine if the coefficient transpose process is needed. If the transpose flag FL associated with a current TB indicates that the coefficient transpose process is not needed for the current TB, the coefficient transpose process is bypassed. If the transpose flag FL associated with the current TB indicates that the coefficient transpose process is needed for the current TB, the flow proceeds with step 304. At step 304, the write control circuit 206 checks if the IS storage device 201 is ready to receive coefficients of one CG in the current TB. The read circuit 210 shown in FIG. 2 is arranged to read coefficients from the IS storage device 210 to the following processing stage (e.g., inverse quantization circuit 106 shown in FIG. 1). When the IS storage device 210 is full with coefficients that are waiting to be transferred to the following processing stage (e.g., inverse quantization circuit 106 shown in FIG. 1), the IS storage device 210 has no free storage space available for buffering new coefficients. If the IS storage device 201 is not ready to receive coefficients yet, the flow proceeds with step 306 to wait for the IS storage device 201 ready to receive coefficients. If the IS storage device 201 is ready to receive coefficients, the flow proceeds with steps 308 and 310.

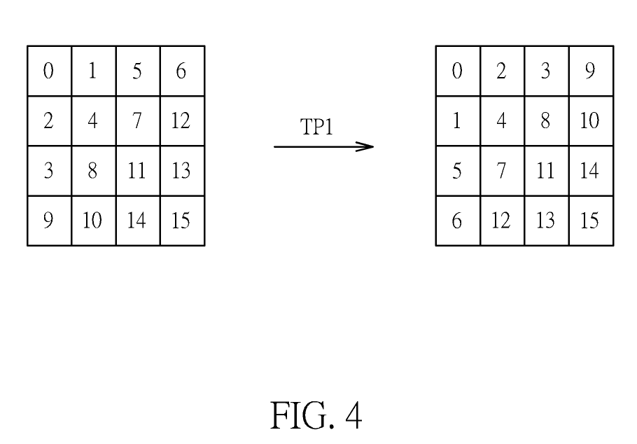

At step 308, the first transpose processing circuit 212 performs the first transpose process (e.g., internal CG transpose process) 124 to determine a transposed coefficient position of a coefficient C_{eff} in a CG after the coefficient C_{eff} is generated from the entropy decoder (e.g., entropy decoder 102 shown in FIG. 1) and received by the receiving circuit 204. FIG. 4 is a diagram illustrating a first transpose process (e.g., internal 4×4 CG transpose process) TP1 applied to one 4×4 CG according to an embodiment of the present invention. The left part of FIG. 4 shows an arrangement of 16 coefficients in a 4×4 CG before the first transpose process (e.g., internal 4×4 CG transpose process) TP1 is applied to the 4×4 CG, and the right part of FIG. 4 shows an arrangement of 16 coefficients in the 4×4 CG after the first transpose process (e.g., internal 4×4 CG transpose process) TP1 is applied to the 4×4 CG. As shown in FIG. 4, one 4×4 CG may include 16 coefficients that are assigned with different index values 0-15. The index values represent the entropy decode coefficient order. In other words, the 16 coefficients are generated from the entropy decoder (e.g., entropy decoder 102 shown in FIG. 1) in an order of 0→1 →. . . →15.

As shown in the left part of FIG. 4, a non-transposed coefficient position of a coefficient with an index value ‘0’ is [0] [0], a non-transposed coefficient position of a coefficient with an index value ‘1’ is [1] [0], a non-transposed coefficient position of a coefficient with an index value ‘5’ is [2] [0], a non-transposed coefficient position of a coefficient with an index value ‘6’ is [3] [0], a non-transposed coefficient position of a coefficient with an index value ‘2’ is [0] [1], a non-transposed coefficient position of a coefficient with an index value ‘4’ is [1] [1], a non-transposed coefficient position of a coefficient with an index value ‘7’ is [2] [1], a non-transposed coefficient position of a coefficient with an index value ‘12’ is [3] [1], a non-transposed coefficient position of a coefficient with an index value ‘3’ is [0] [2], a non-transposed coefficient position of a coefficient with an index value ‘8’ is [1] [2], a non-transposed coefficient position of a coefficient with an index value ‘11’ is [2] [2], a non-transposed coefficient position of a coefficient with an index value ‘13’ is [3] [2], a non-transposed coefficient position of a coefficient with an index value ‘9’ is [0] [3], a non-transposed coefficient position of a coefficient with an index value ‘10’ is [1] [3], a non-transposed coefficient position of a coefficient with an index value ‘14’ is [2] [3], and a non-transposed coefficient position of a coefficient with an index value ‘15’ is [3] [3].

The first transpose process (e.g. , internal 4×4 CG transpose process) TP1 can assign transposed coefficient positions to coefficients in the same CG. As shown in the right part of FIG. 4, a transposed coefficient position of a coefficient with an index value ‘0’ is [0] [0], a transposed coefficient position of a coefficient with an index value ‘1’ is [0] [1], a transposed coefficient position of a coefficient with an index value ‘5’ is [0] [2], a transposed coefficient position of a coefficient with an index value ‘6’ is [0] [3], a transposed coefficient position of a coefficient with an index value ‘2’ is [1] [0], a transposed coefficient position of a coefficient with an index value ‘4’ is [1] [1], a transposed coefficient position of a coefficient with an index value ‘7’ is [1] [2], a transposed coefficient position of a coefficient with an index value ‘12’ is [1] [3], a transposed coefficient position of a coefficient with an index value ‘3’ is [2] [0], a transposed coefficient position of a coefficient with an index value ‘8’ is [2] [1], a transposed coefficient position of a coefficient with an index value ‘11’ is [2] [2], a transposed coefficient position of a coefficient with an index value ‘13’ is [2] [3], a transposed coefficient position of a coefficient with an index value ‘9’ is [3] [0], a transposed coefficient position of a coefficient with an index value ‘10’ is [3] [1], a transposed coefficient position of a coefficient with an index value ‘14’ is [3] [2], and a transposed coefficient position of a coefficient with an index value ‘15’ is [3] [3].

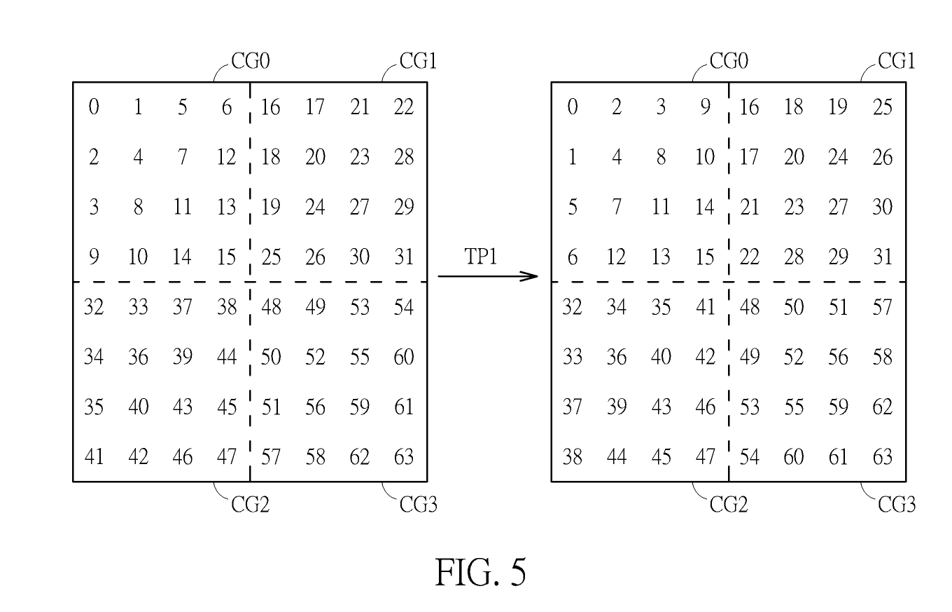

FIG. 5 is a diagram illustrating a first transpose process (e.g., internal 4×4 CG transpose process) TP1 applied to different 4×4 CGs in the same 8×8 TB according to an embodiment of the present invention. The left part of FIG. 5 shows an arrangement of 64 coefficients in a 8×8 TB (which is partitioned into four 4×4 CGs denoted by CG0, CG1, CG2, CG3) before the first transpose process (e.g., internal 4×4 CG transpose process) TP1 is applied to any of the 4×4 CGs, and the right part of FIG. 5 shows an arrangement of 64 coefficients in the 8×8 TB (which is partitioned into four 4×4 CGs denoted by CG0, CG1, CG2, CG3) after the first transpose process (e.g., internal 4×4 CG transpose process) TP1 is applied to all of the 4×4 CGs. Regarding a coefficient in any CG of the TB that is generated from the entropy decoder (e.g., entropy decoder 102 shown in FIG. 1), a transposed coefficient position of the coefficient can be determined by the first transpose process (e.g., internal 4×4 CG transpose process) TP1.

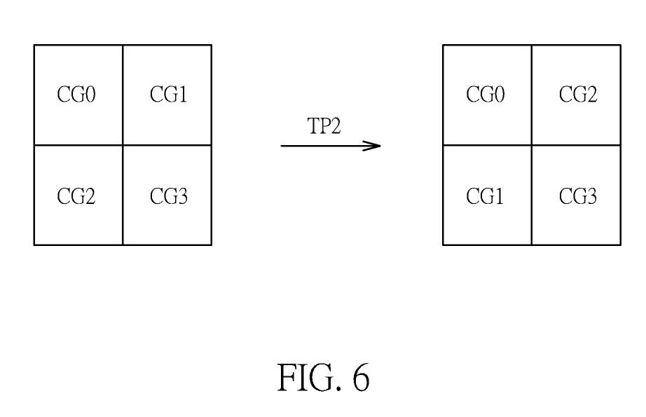

At step 310, the second transpose processing circuit 214 performs the second transpose process (e.g., external CG transpose process) 124 to determine a transposed CG position of the CG in the TB after the coefficient C_{eff} is generated from the entropy decoder (e.g., entropy decoder 102 shown in FIG. 1) and received by the receiving circuit 204. FIG. 6 is a diagram illustrating a second transpose process (e.g., external 4×4 CG transpose process) TP2 applied to 4×4 CGs of one 8×8 TB according to an embodiment of the present invention. The left part of FIG. 6 shows an arrangement of four 4×4 CGs before the second transpose process (e.g., external 4×4 CG transpose process) TP2 is applied to the 4×4 CGs in one 8×8 TB, and the right part of FIG. 6 shows an arrangement of four 4×4 CGs after the second transpose process (e.g., external 4×4 CG transpose process) TP2 is applied to the 4×4 CGs in one 8×8 TB. As shown in FIG. 4, four 4×4 CGs are assigned with different index values 0, 1, 2, 3 as indicated by suffixes of the symbols ‘CG0’, ‘CG1’, ‘CG2’, ‘CG3’. The index values represent the entropy decode 4×4 CG order. In other words, the fours CGs in one 8×8 TB are generated from the entropy decoder (e.g., entropy decoder 102 shown in FIG. 1) in an order of 0=1→2→3.

As shown in the left part of FIG. 6, a non-transposed CG position of a CG with an index value ‘0’ (i.e., CG0) is [0] [0], a non-transposed CG position of a CG with an index value ‘1’ (i.e., CG1) is [1] [0], a non-transposed CG position of a CG with an index value ‘2’ (i.e., CG2) is [0] [1], and a non-transposed CG position of a CG with an index value ‘3’ (i.e., CG3) is [1] [1].

The second transpose process (e.g., external 4×4 CG transpose process) TP2 can determine transposed CG positions of CGs in the same TB. As shown in the right part of FIG. 6, a transposed CG position of a CG with an index value ‘0’ (i.e., CG0) is [0] [0], a transposed CG position of a CG with an index value ‘1’ (i.e., CG1) is [0] [1], a transposed CG position of a CG with an index value ‘2’ (i.e., CG2) is [1] [0], and a transposed CG position of a CG with an index value ‘3’ (i.e., CG3) is [1] [1].

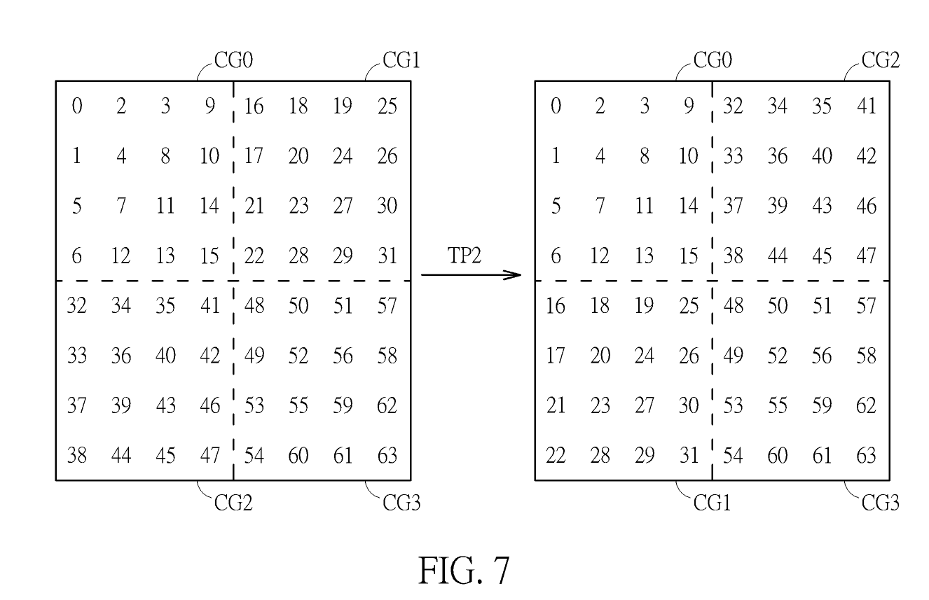

FIG. 7 is a diagram illustrating a second transpose process (e.g., external 4×4 CG transpose process) TP2 applied to different 4×4 CGs in the same 8×8 TB according to an embodiment of the present invention. The left part of FIG. 7 shows an arrangement of 64 coefficients in a 8×8 TB (which is partitioned into four 4×4 CGs denoted by CG0, CG1, CG2, CG3) before the second transpose process (e.g., external 4×4 CG transpose process) TP2 is applied to any of the 4×4 CGs, and the right part of FIG. 7 shows an arrangement of 64 coefficients in the 8×8 TB (which is partitioned into four 4×4 CGs denoted by CG0, CG1, CG2, CG3) after the second transpose process (e.g., external 4×4 CG transpose process) TP2 is applied to all of the 4×4 CGs. For clarity and simplicity, it is assumed that the second transpose process (e.g., external 4×4 CG transpose process) TP2 is applied to 4×4 CGs of an 8×8 TB after the first transpose process (e.g., internal 4×4 CG transpose process) TP1 is applied to each 4×4 CG in the 8×8 TB. Hence, the arrangement of 64 coefficients in the 8×8 TB before the second transpose process (e.g., external 4×4 CG transpose process) TP2 is applied to any of the 4×4 CGs as shown in the left part of FIG. 7 is same as the arrangement of 64 coefficients in the 8×8 TB after the first transpose process (e.g., internal 4×4 CG transpose process) TP1 is applied to all of the 4×4 CGs as shown in the right part of FIG. 5. However, this is for illustrative purposes only, and is not meant to be a limitation of the present invention. Regarding a coefficient in any CG of the TB that is generated from the entropy decoder (e.g., entropy decoder 102 shown in FIG. 1), a transposed CG position of a CG to which the received coefficient belongs can be determined by the second transpose process (e.g., external 4×4 CG transpose process) TP2 based on the CG index generated from the entropy decoder (e.g., entropy decoder 102 shown in FIG.

To achieve better video decoding performance, the first transpose processing circuit 212 and the second transpose processing circuit 214 may be arranged to perform the first transpose process (step 308) and the second transpose process (step 310) in a parallel manner. In other words, concerning computation of a transposed coefficient position of a coefficient and a transposed CG position of a CG to which the coefficient belongs, the processing time of the first transpose process overlaps the processing time of the second transpose process. Alternatively, the first transpose processing circuit 212 and the second transpose processing circuit 214 may be arranged to perform the first transpose process (step 308) and the second transpose process (step 310) in a sequential manner. For example, concerning computation of a transposed coefficient position of a coefficient and a transposed CG position of a CG to which the coefficient belongs, one of the first transpose process and the second transpose process is not started until the other of the first transpose process and the second transpose process is done.

After the transposed coefficient position is determined by the first transpose processing circuit 212, the storage position determining circuit 216 determines the storage position of the received coefficient C_{eff} in the CG according to the transposed coefficient position (step 312). Next, the write circuit 208 writes the received coefficient C_{eff} in the CG into the determined storage position in the IS storage device 201 (step 314). Taking the CG shown in FIG. 4 for example, coefficient storage positions are properly determined by the storage position determining circuit 216 for coefficients with transposed coefficient positions. Suppose that one memory word is capable of buffering four coefficients. Hence, coefficients with index values 0, 1, 5, 6 may be stored in a first memory word, coefficients with index values 2, 4, 7, 2 may be stored in a second memory word, coefficients with index values 3, 8, 11, 13 may be stored in a third memory word, and coefficients with index values 9, 10, 14, 15 may be stored in a fourth memory word. However, in a case where the transpose flag FL indicates that the coefficient transpose process is not needed, coefficients with index values 0, 2, 3, 9 may be stored in the first memory word, coefficients with index values 1, 4, 8, 0 may be stored in the second memory word, coefficients with index values 5, 7, 11, 14 may be stored in the third memory word, and coefficients with index values 6, 12, 13, 15 may be stored in the fourth memory word.

In addition, after the transposed CG position is determined by the second transpose processing circuit 214, the transposed CG position is further supplied to the write circuit 208. In one exemplary design, the write circuit 208 further refers to the transposed CG position to control writing of the received coefficient C_{eff} in the IS storage device 201. That is, when the coefficient transpose process is needed, the write circuit 208 determines a write address of a received coefficient C_{eff} according to a coefficient storage position determined by the storage position and a CG position determined by the second transpose processing circuit 214. For example, the CG position may be mapped to a particular base address in the IS storage device 201, and the coefficient storage position may act as an address offset. However, if at least one of CGs in the TB may be skipped due to certain factors, at least one storage space allocated in the IS storage device 201 may be filled with predetermined values (e.g., 0's) due to the at least one skipped CG. As a result, the IS storage device 201 is not used in an efficient way.

In another exemplary design, the CG position determined by the second transpose processing circuit 214 is directly stored into the IS storage device 318 by the write circuit 208 (step 318). Since transposed coefficients of non-skipped CGs are stored into the IS storage device 201 without considering the transposed CG positions, there is no need to reserve one storage space in the IS storage device 201 for each skipped CG. The write circuit 208 stores transposed coefficients C_{eff} of each non-skipped CG into the IS storage device 201 under the control of coefficient storage positions determined by the storage position determining circuit 216 only. For example, supposing that CG1 and CG2 in the same TB are skipped, the write circuit 208 directly stores transposed CG positions of non-skipped CG0 and CG3 into available memory words of the IS storage device 201, and stores transposed coefficients of non-skipped CG0 and CG3 into available memory words of the IS storage device 201 according to the coefficient storage positions determined by the storage position determining circuit 216. For example, transposed coefficients of non-skipped CG0 and CG3 may be stored into continuous memory words of the IS storage device 201. The read circuit 210 may refer to the transposed CG positions of non-skipped CG0 and CG3 obtained from the IS storage device 201 to correctly get the transposed coefficients from the IS storage device 201 in the transposed scan/readout order. To put it simply, the transposed coefficient (which is not influenced by the transposed CG position) in the IS storage device 201 and the transposed CG position in the IS storage device 201 may be combined to get the transposed coefficient. However, this is for illustrative purposes only, and is not meant to be a limitation of the present invention.

At step 316, the write control circuit 206 checks if the current CG is the last CG of the TB. If the current CG is the last CG of the TB, the coefficient transpose process of the TB is done. If the current CG is not the last CG of the TB, the flow proceeds with step 304 to check if the IS storage device 201 is ready to receive coefficients of the next CG in the TB.

As mentioned above, before a coefficient C_{eff} received by the receiving circuit 204 is stored into the IS storage device 201, the write control circuit 206 determines a storage position of the received coefficient C_{eff} according to the transpose flag FL associated with a TB (which includes the received coefficient C_{eff}). When the transpose flag FL indicates that a coefficient transpose process is not needed, the storage position determining circuit 216 determines the storage position of the received coefficient C_{eff} according to a non-transposed coefficient position of the received coefficient C_{eff} that is not needed to undergo processing (e.g., internal CG transpose processing) of the first transpose processing circuit 212, and a non-transposed CG position of a CG to which the received coefficient C_{eff} belongs is bypassed to the write circuit 208 without undergoing processing (e.g., external CG transpose processing) of the second transpose processing circuit 214. When the transpose flag FL indicates that a coefficient transpose process is needed, the storage position determining circuit 216 determines the storage position of the received coefficient C_{eff} according to a transposed coefficient position of the received coefficient C_{eff} that is determined by processing (e.g., internal CG transpose processing) of the first transpose processing circuit 212. After combining the transposed coefficient in IS storage device 201 and the transposed CG position, a single IS storage device can support a non-transposed scan/readout order of coefficients for the following processing stage (e.g., inverse quantization) by storing coefficients of a TB without the coefficient transpose process applied thereto, and can also support a transposed scan/readout order of coefficients for the following processing stage (e.g., inverse quantization) by storing coefficients of the TB with the coefficient transpose process applied thereto. That is, the inverse scan circuit 200 does not need to have a first IS storage device that is used to support a non-transposed scan/readout order of coefficients for the following processing stage (e.g., inverse quantization) by storing coefficients of a TB without the coefficient transpose process applied thereto, and a second IS storage device that is used to support a transposed scan/readout order of coefficients for the following processing stage (e.g., inverse quantization) by storing coefficients of the TB without the coefficient transpose process applied thereto. To put is simply, the coefficient access apparatus 202 with the proposed coefficient transpose function enables a low-cost inverse scan which only needs a single IS storage device (e.g., IS storage device 201) to support different scan/readout orders of coefficients for the following processing stage (e.g., inverse quantization).

Moreover, the coefficient access apparatus 202 with the proposed coefficient transpose function also enables a high throughput of the single IS storage device 201 under a transposed scan/readout order of coefficients for the following processing stage (e.g., inverse quantization). Further details are described as below.

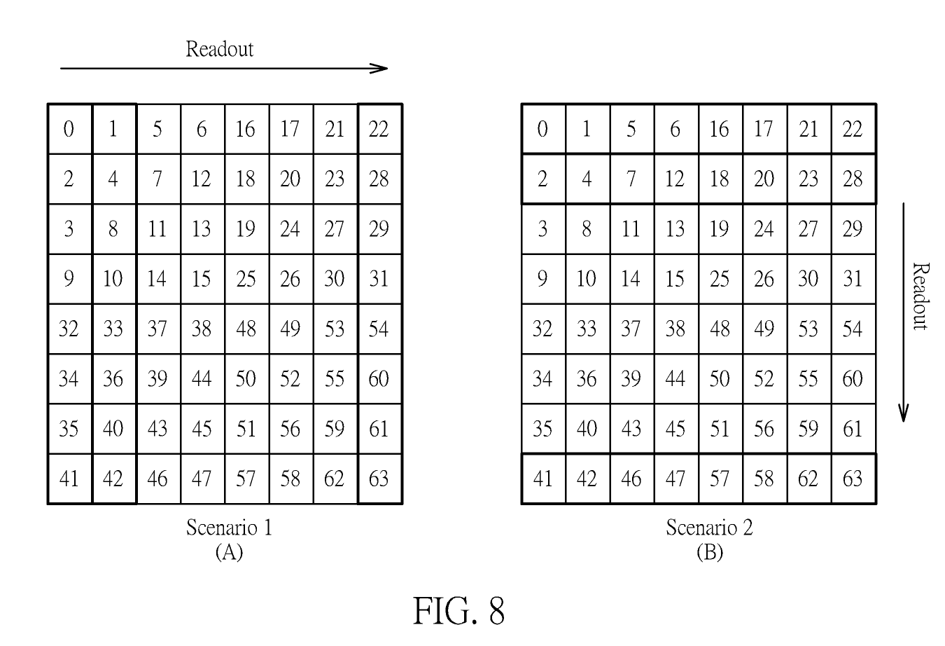

FIG. 8 is a diagram illustrating two coefficient input scenarios of inverse quantization according to an embodiment of the present invention. The sub-diagram (A) of FIG. 8 shows a first coefficient input scenario of inverse quantization. The non-transposed scan/readout order of coefficients from IS to IQ is in a column scan order and is from upper left to bottom right. Hence, the non-transposed scan/readout order of coefficients from IS to IQ is 0→2→9→32→34→35→41→1→4→8→10 . . . →54→60→61→63, where the index values 0-63 represent an entropy decode coefficient order. The sub-diagram (B) of FIG. 8 shows a second coefficient input scenario of inverse quantization. The transposed scan/readout order of coefficients from IS to IQ is in a row scan order and is from upper left to bottom right. Hence, the transposed scan/readout order of coefficients from IS to IQ is 0→1→5→6→16→17→21→22→2→4→7→12 . . . →57→58→62→63, where the index values 0-63 represent an entropy decode coefficient order.

With regard to the first coefficient input scenario of inverse quantization, the IS storage device 201 may store coefficients in a particular footprint to meet a throughput requirement of the inverse quantization process.

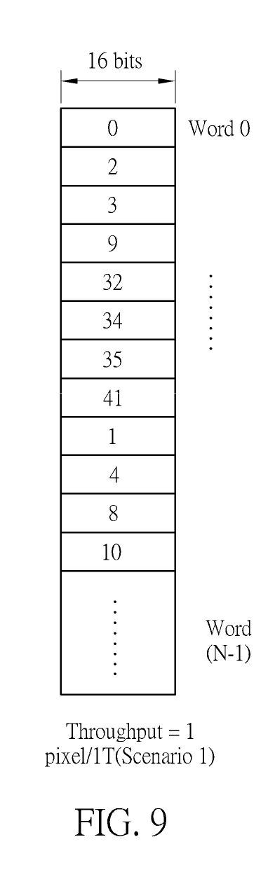

FIG. 9 is a diagram illustrating a first footprint of an IS storage device according to an embodiment of the present invention. In this example, the throughput requirement of the inverse quantization process is one pixel per clock cycle (i.e., 1 pixel/1 T). Supposing that the IS storage device 201 is an IS SRAM, the IS SRAM maybe configured to have N SRAM words (denoted by Word 0-Word (N−1)). In this example, the SRAM word size is 16 bits. Each of the N SRAM words is used to store a coefficient of a pixel in a TB, where N represents the number of coefficients in the TB. As shown in FIG. 9, a coefficient at a coefficient position [0] [0] in the TB is stored into an SRAM word ‘Word 0’, a coefficient at a coefficient position [0] [1] in the TB is stored into an SRAM word ‘Word 1’, a coefficient at a coefficient position [0] [2] in the TB is stored into an SRAM word ‘Word 2’, a coefficient at a coefficient position [0] [3] in the TB is stored into an SRAM word ‘Word 3’, a coefficient at a coefficient position [0] [4] in the TB is stored into an SRAM word ‘Word 4’, a coefficient at a coefficient position [0] [5] in the TB is stored into an SRAM word ‘Word 5’, a coefficient at a coefficient position [0] [6] in the TB is stored into an SRAM word ‘Word 6’, a coefficient at a coefficient position [0] [7] in the TB is stored into an SRAM word ‘Word 7’, a coefficient at a coefficient position [1] [0] in the TB is stored into an SRAM word ‘Word 8’, and so on. Hence, when the SRAM words ‘Word 0’-‘Word (N−1)’ are sequentially read by a read circuit (e.g., read circuit 210 shown in FIG. 2) in N clock cycles, the coefficients in the IS storage device 201 are fed into the following processing stage (e.g., inverse quantization) in the non-transposed scan/readout order 0→2→3→9→32→34→35→41→1→4→8→10 →. . . as shown in the sub-diagram (A) of FIG. 8. In addition, each of the N SRAM words can output one coefficient in one clock cycle T to meet the throughput requirement of the inverse quantization process under the non-transposed scan/readout order.

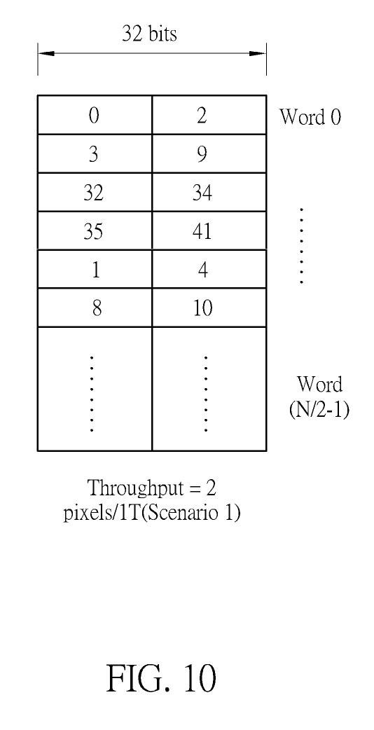

FIG. 10 is a diagram illustrating a second footprint of an IS storage device according to an embodiment of the present invention. In this example, the throughput requirement of the inverse quantization process is two pixels per clock cycle (i.e., 2 pixels/1 T). Supposing that the IS storage device 201 is an IS SRAM, the IS SRAM may be configured to have (N/2) SRAM words (denoted by Word 0-Word (N/2−1)). In this example, the SRAM word size is 32 bits. Each of the N SRAM words is used to store coefficients of two pixels in a TB, where N represents the number of coefficients in the TB. As shown in FIG. 10, coefficients at coefficient positions [0] [0] and [0] [1] in the TB are stored into an SRAM word ‘Word 0’, coefficients at coefficient positions [0] [2] and [0] [3] in the TB are stored into an SRAM word ‘Word 1’, coefficients at coefficient positions [0] [4] and [0] [5] in the TB are stored into an SRAM word ‘Word 2’, coefficients at coefficient positions [0] [6] and [0] [7] in the TB are stored into an SRAM word ‘Word 3’, coefficients at coefficient position [1] [0] and [1] [1] in the TB are stored into an SRAM word ‘Word 4’, and so on. Hence, when the SRAM words ‘Word 0’−‘Word (N/2−1)’ are sequentially read by a read circuit (e.g., read circuit 210 shown in FIG. 2) in (N/2) clock cycles, the coefficients in the IS storage device 201 are fed into the following processing stage (e.g., inverse quantization) in the non-transposed scan/readout order 0, 2→3, 9→32, 34→35, 41→1, 4→8, as shown in the sub-diagram (A) of FIG. 8. In addition, each of the (N/2) SRAM words can output two coefficients in one clock cycle T to meet the throughput requirement of the inverse quantization process under the non-transposed scan/readout order.

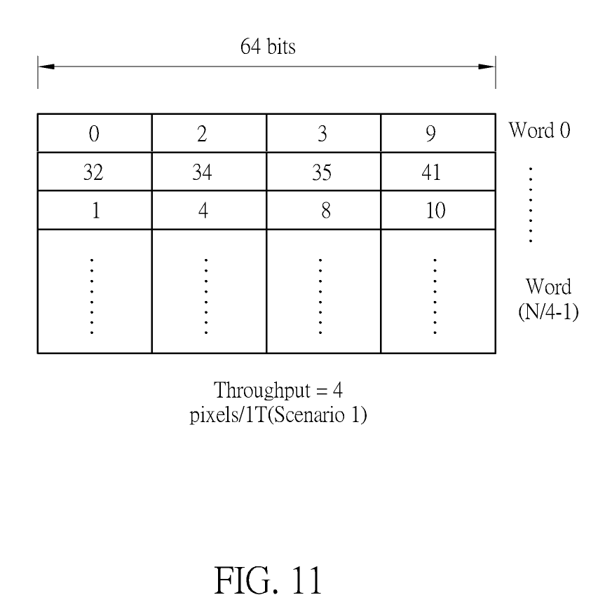

FIG. 11 is a diagram illustrating a third footprint of an IS storage device according to an embodiment of the present invention. In this example, the throughput requirement of the inverse quantization process is four pixels per clock cycle (i.e., 4 pixels/1 T). Supposing that the IS storage device 201 is an IS SRAM, the IS SRAM may be configured to have (N/4) SRAM words (denoted by Word 0-Word (N/4−1)). In this example, the SRAM word size is 64 bits. Each of the N SRAM words is used to store coefficients of four pixels in a TB, where N represents the number of coefficients in the TB. As shown in FIG. 11, coefficients at coefficient positions [0] [0], [0] [1], [0] [2] and [0] [3] in the TB are stored into an SRAM word ‘Word 0’, coefficients at coefficient positions [0] [4], [0] [5], [0] [6] and [0] [7] in the TB are stored into an SRAM word ‘Word 1’, coefficients at coefficient positions [1] [0], [1] [1], [1] [2] and [1] [3] in the TB are stored into an SRAM word ‘Word 2’, and so on. Hence, when the SRAM words ‘Word 0’−‘Word (N/4−1)’ are sequentially read by a read circuit (e.g., read circuit 210 shown in FIG. 2) in (N/4) clock cycles, the coefficients in the IS storage device 201 are fed into the following processing stage (e.g., inverse quantization) in the non-transposed scan/readout order 0, 2, 3, 9→32, 34, 35, 41→1, 4, 8, 10 →. . . as shown in the sub-diagram (A) of FIG. 8. In addition, each of the (N/4) SRAM words can output four coefficients in one clock cycle T to meet the throughput requirement of the inverse quantization process under the non-transposed scan/readout order.

When the throughput requirement of the inverse quantization process is two pixels per clock cycle (i.e., 2 pixels/1 T), the second footprint shown in FIG. 10 can meet the throughput requirement under the non-transposed scan/readout order shown in the sub-diagram (A) of FIG. 8, but is unable to meet the throughput requirement under the transposed scan/readout order shown in the sub-diagram (B) of FIG. 8. Specifically, to meet the throughput requirement under the transposed scan/readout order shown in the sub-diagram (B) of FIG. 8, required coefficients at two coefficient positions (e.g., [0] [0] and [1] [0]) should be read from an IS storage device in one clock cycle. However, in accordance with the second footprint shown in FIG. 10, required coefficients at two coefficient positions are stored in different SRAM words. For example, the coefficient at coefficient position [0] [0] is stored in one SRAM word ‘Word 0’, and the coefficient at coefficient position [1] [0] is stored in another SRAM word ‘Word 4’.

When the throughput requirement of the inverse quantization process is four pixels per clock cycle (i.e., 4 pixels/1 T), the third footprint shown in FIG. 11 can meet the throughput requirement under the non-transposed scan/readout order shown in the sub-diagram (A) of FIG. 8, but is unable to meet the throughput requirement under the transposed scan/readout order shown in the sub-diagram (B) of FIG. 8. Specifically, to meet the throughput requirement under the transposed scan/readout order shown in the sub-diagram (B) of FIG. 8, required coefficients at four coefficient positions (e.g., [0] [0], [1] [0], [2] [0] and [3] [0]) should be read from an IS storage device in one clock cycle. However, in accordance with the third footprint shown in FIG. 11, required coefficients at four coefficient positions (e.g., [0] [0], [1] [0], [2] [0] and [3] [0]) are not stored in the same SRAM word.

With the help of the proposed coefficient transpose process, the footprint of the IS storage device can be properly modified to meet the throughput requirement of the inverse quantization process (e.g., 2 pixels/1 T or 4 pixels/1 T) under the transposed scan/readout order shown in the sub-diagram (B) of FIG. 8. When the transpose flag FL indicates that a coefficient transpose process, including a first transpose process (e.g., internal CG transpose process) and a second transpose process (e.g., external CG transpose process), is needed due to a transposed scan/readout order required by coefficient input of inverse quantization, a coefficient at a transposed coefficient position in a TB will be stored into the IS storage device 201. For example, coefficients at transposed coefficient positions in an 8×8 TB may be stored into the IS storage device 201 according to the transposed coefficient arrangement as shown in the right part of FIG. 7.

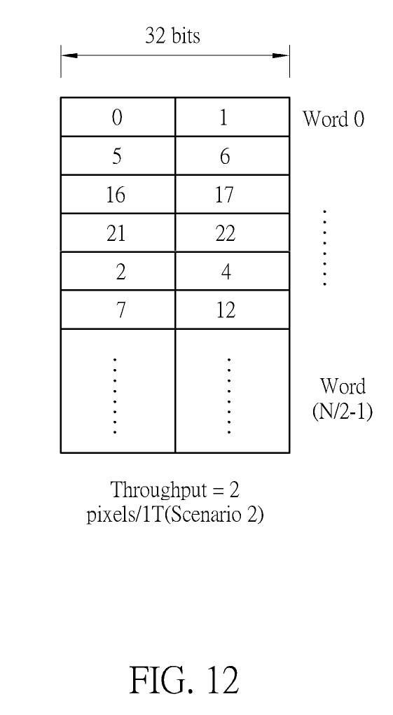

FIG. 12 is a diagram illustrating a modified second footprint of an IS storage device according to an embodiment of the present invention. In this example, the throughput requirement of the inverse quantization process is two pixels per clock cycle (i.e., 2 pixels/1 T). Supposing that the IS storage device 201 is an IS SRAM, the IS SRAM may be configured to have (N/2) SRAM words (denoted by Word 0-Word (N/2−1)). In this example, the SRAM word size is 32 bits. Each of the N SRAM words is used to store coefficients of two pixels in a TB, where N represents the number of coefficients in the TB. As shown in FIG. 12, coefficients at transposed coefficient positions [0] [0] and [0] [1] in the TB as illustrated in the right part of FIG. 7 are stored into an SRAM word ‘Word 0’, coefficients at transposed coefficient positions [0] [2] and [0] [3] in the TB as illustrated in the right part of FIG. 7 are stored into an SRAM word ‘Word 1’, coefficients at transposed coefficient positions [0] [4] and [0] [5] in the TB as illustrated in the right part of FIG. 7 are stored into an SRAM word ‘Word 2’, coefficients at transposed coefficient positions [0] [6] and [0] [7] in the TB as illustrated in the right part of FIG. 7 are stored into an SRAM word ‘Word 3’, coefficients at transposed coefficient position [1] [0] and [1] [1] in the TB as illustrated in the right part of FIG. 7 are stored into an SRAM word ‘Word 4’, and so on. Hence, when the SRAM words ‘Word 0’-‘Word (N/2−1)’ are sequentially read by a read circuit (e.g., read circuit 210 shown in FIG. 2) in (N/2) clock cycles, the coefficients in the IS storage device 201 are fed into the following processing stage (e.g., inverse quantization) in the transposed scan/readout order 0, 1→5, 6→16, 17→21, 22→2, 4→7, 12 →. . . as shown in the sub-diagram (B) of FIG. 8. In addition, each of the (N/2) SRAM words can output two coefficients in one clock cycle T to meet the throughput requirement of the inverse quantization process under the transposed scan/readout order.

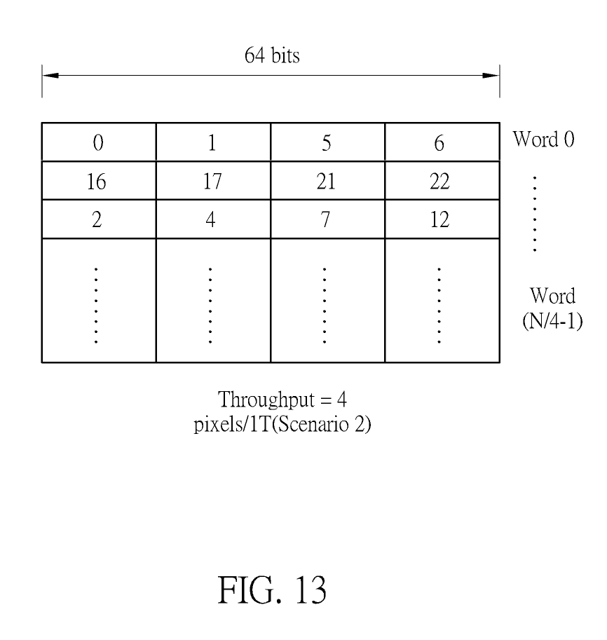

FIG. 13 is a diagram illustrating a modified third footprint of an IS storage device according to an embodiment of the present invention. In this example, the throughput requirement of the inverse quantization process is four pixels per clock cycle (i.e., 4 pixels/1 T). Supposing that the IS storage device 201 is an IS SRAM, the IS SRAM may be configured to have (N/4) SRAM words (denoted by Word 0-Word (N/4−1)). In this example, the SRAM word size is 64 bits. Each of the N SRAM words is used to store coefficients of four pixels in a TB, where N represents the number of coefficients in the TB. As shown in FIG. 13, coefficients at transposed coefficient positions [0] [0], [0] [1], [0] [2] and [0] [3] in the TB as illustrated in the right part of FIG. 7 are stored into an SRAM word ‘Word 0’, coefficients at transposed coefficient positions [0] [4], [0] [5], [0] [6] and [0] [7] in the TB as illustrated in the right part of FIG. 7 are stored into an SRAM word ‘Word 1’, coefficients at transposed coefficient positions [1] [0], [1] [1], [1] [2] and [1] [3] in the TB as illustrated in the right part of FIG. 7 are stored into an SRAM word ‘Word 2’, and so on. Hence, when the SRAM words ‘Word 0’−‘Word (N/4-1)’ are sequentially read by a read circuit (e.g., read circuit 210 shown in FIG. 2) in (N/4) clock cycles, the coefficients in the IS storage device 201 are fed into the following processing stage (e.g., inverse quantization) in the transposed scan/readout order 0, 1, 5, 6→16, 17, 21, 22→2, 4, 7, 12 →. . . as shown in the sub-diagram (B) of FIG. 8. In addition, each of the (N/4) SRAM words can output four coefficients in one clock cycle T to meet the throughput requirement of the inverse quantization process under the transposed scan/readout order.

In a case where the throughput requirement of the inverse quantization process is two pixels per clock cycle (i.e., 2 pixels/1 T), the second footprint shown in FIG. 10 is employed by the IS storage device 201 when the transpose flag FL indicates that the proposed coefficient transpose process is not needed, and the modified second footprint shown in FIG. 12 is employed by the IS storage device 201 when the transpose flag FL indicates that the proposed coefficient transpose process is needed. In this way, a high-performance and low-cost inverse scan design can be achieved under different scan/readout orders of coefficients for inverse quantization.

In another case where the throughput requirement of the inverse quantization process is four pixels per clock cycle (i.e., 4 pixels/1 T), the third footprint shown in FIG. 11 is employed by the IS storage device 201 when the transpose flag FL indicates that the proposed coefficient transpose process is not needed, and the modified third footprint shown in FIG. 13 is employed by the IS storage device 201 when the transpose flag FL indicates that the proposed coefficient transpose process is needed. In this way, a high-performance and low-cost inverse scan design can be achieved under different scan/readout orders of coefficients for inverse quantization.

It should be noted that, when the transpose flag FL indicates that the proposed coefficient transpose process is needed, the read circuit 210 can directly read coefficients from the IS storage device 201 to the following processing stage (e.g., inverse quantization circuit 106 shown in FIG. 1) due to the fact that the coefficients are stored into the IS storage device 201 under control of the proposed coefficient transpose process. In other words, no additional coefficient transpose process is needed to process all stored coefficients of one TB in the IS storage device 201 before the stored coefficients of the TB are transferred from the IS storage device 201 to the following processing stage (e.g., inverse quantization circuit 106 shown in FIG. 1).

As mentioned above, when the second footprint shown in FIG. 10 is used by the IS storage device 201 to store coefficients, coefficients at non-transposed coefficient positions [0] [0] and [0] [1] as illustrated in the left part of FIG. 5 are stored into an SRAM word ‘Word 0’, coefficients at non-transposed coefficient positions [0] [2] and [0] [3] as illustrated in the left part of FIG. 5 are stored into an SRAM word ‘Word 1’, coefficients at non-transposed coefficient positions [0] [4] and [0] [5] as illustrated in the left part of FIG. are stored into an SRAM word ‘Word 2’, and coefficients at non-transposed coefficient positions [0] [6] and [0] [7] as illustrated in the left part of FIG. 5 are stored into an SRAM word ‘Word 3’; and when the modified second footprint shown in FIG. 12 is used by the IS storage device 201 to store coefficients, coefficients at transposed coefficient positions [0] [0] and [0] [1] as illustrated in the right part of FIG. 7 are stored into an SRAM word ‘Word 0’, coefficients at transposed coefficient positions [0] [2] and [0] [3] as illustrated in the right part of FIG. 7 are stored into an SRAM word ‘Word 1’, coefficients at transposed coefficient positions [0] [4] and [0] [5] as illustrated in the right part of FIG. 7 are stored into an SRAM word ‘Word 2’, and coefficients at transposed coefficient positions [0] [6] and [0] [7] as illustrated in the right part of FIG. 7 are stored into an SRAM word ‘Word 3’. Hence, the read behavior of the read circuit 210 under a non-transposed scan/readout order of coefficients for inverse quantization is same as the read behavior of the read circuit 210 under a transposed scan/readout order of coefficients for inverse quantization. Based on such observation, the same mapping table LUT can be used by the read circuit 210 to read coefficients in either of a non-transposed scan/readout order and a transposed scan/readout order, where the mapping table LUT records mapping between storage positions (e.g., SRAM word addresses) and coefficient positions. Since there is no need to maintain a first mapping table used for reading coefficients in a non-transposed scan/readout order and a second mapping table (i.e., a transpose table) used for reading coefficients in a transposed scan/readout order, the hardware cost can be further reduced.

In above embodiment shown in FIG. 2, the coefficient access apparatus 202 maybe implemented using dedicated hardware, such that the proposed coefficient transpose process may be implemented in hardware. However, this is for illustrative purposes only, and is not meant to be a limitation of the present invention. Alternatively, the proposed coefficient transpose process may be implemented in software.

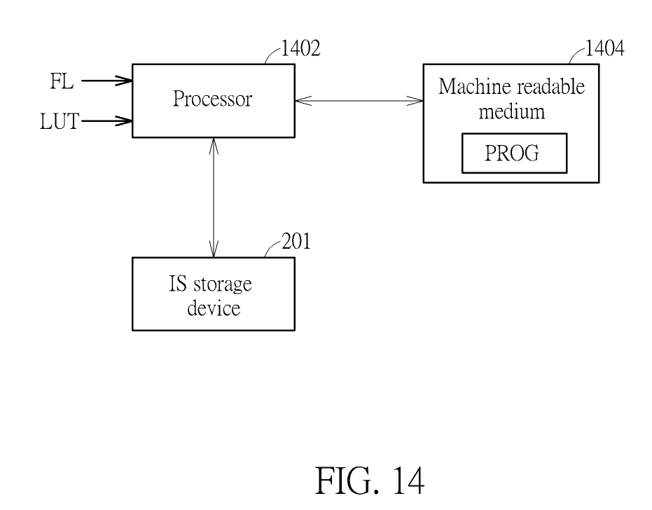

FIG. 14 is a diagram illustrating an inverse scan design with software-based coefficient access control according to an embodiment of the present invention. A program code PROG is stored in a machine readable medium 1404. For example, the machine readable medium 1404 maybe a non-volatile memory such as a flash memory. When the program code PROG is loaded and executed by a processor 1402, the program code PROG instructs the processor 1402 to perform the control flow shown in FIG. 3. That is, the same function and operation possessed by the aforementioned coefficient access apparatus 202 are achieved by the program code PROG running on the processor 1402. For example, the processor 1402 determines a storage position of each received coefficient according to the transpose flag FL, and stores the received coefficient into the determined storage position of the IS storage device 201. For another example, the processor 1402 refers to the same mapping table LUT to read coefficients from the IS storage device 201 to the following processing stage (e.g., inverse quantization circuit 106 shown in FIG. 1) in either of a non-transposed scan/readout order and a transposed scan/readout order. As a person skilled in the art can readily understand the principle of the software-based coefficient access control of the IS storage device 201 according to above paragraphs directed to the hardware-based coefficient access control of the IS storage device 201, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coefficient access method comprising:
receiving a coefficient generated from an entropy decoding process, wherein the received coefficient is a part of a transform block (TB);
before the received coefficient is stored into an inverse scan (IS) storage device, determining a storage position of the received coefficient according to a transpose flag associated with the TB, wherein the transpose flag indicates whether or not a coefficient transpose process is needed; and
after the storage position is determined, storing the received coefficient into the determined storage position in the IS storage device.

2. The coefficient access method of claim 1, wherein the TB is partitioned into a plurality of coefficient groups (CGs), the coefficient is included in a CG of the TB, and determining the storage position of the received coefficient according to the transpose flag comprises:
when the transpose flag indicates that the coefficient transpose process is needed,
performing a first transpose process to determine a transposed coefficient position of the coefficient in the CG; and
determining the storage position of the received coefficient according to the transposed coefficient position; and
the coefficient access method further comprises:
when the transpose flag indicates that the coefficient transpose process is needed,
performing a second transpose process to determine a transposed CG position of the CG in the TB; and
storing the determined transposed CG position into the IS storage device, wherein the received coefficient is stored into the IS storage device under control of the determined storage position.

3. The coefficient access method of claim 2, wherein the first transpose process and the second transpose process are performed in a parallel manner.

4. The coefficient access method of claim 1, further comprising:
when the transpose flag indicates that the coefficient transpose process is needed, directly reading coefficients of the TB from the IS storage device to an inverse quantization (IQ) process.

5. The coefficient access method of claim 1, wherein when the transpose flag indicates that the coefficient transpose process is not needed, the coefficient is stored into the IS storage device which meets a throughput requirement of an inverse quantization (IQ) process;
and when the transpose flag indicates that the coefficient transpose process is needed, the coefficient is stored into the same IS storage device which meets the same throughput requirement of the IQ process.

6. The coefficient access method of claim 1, further comprising:
when the transpose flag indicates that the coefficient transpose process is not needed, referring to a mapping table to read the coefficient of the TB from the IS storage device to an inverse quantization (IQ) process; and
when the transpose flag indicates that the coefficient transpose process is needed, referring to the same mapping table to read the coefficient of the TB from the IS storage device to the IQ process.

7. The coefficient access method of claim 1, wherein the coefficient access method is a part of a second generation Audio Video Coding Standard (AVS2) decoding process.

8. A coefficient access apparatus comprising:
a receiving circuit, arranged to receive a coefficient generated from an entropy decoder, wherein the received coefficient is a part of a transform block (TB);
a write control circuit, arranged to determine a storage position of the received coefficient according to a transpose flag associated with the TB before the received coefficient is stored into an inverse scan (IS) storage device, wherein the transpose flag indicates whether or not a coefficient transpose process is needed; and
a write circuit, arranged to store the received coefficient into the determined storage position in the IS storage device after the storage position is determined by the write control circuit.

9. The coefficient access apparatus of claim 8, wherein the TB is partitioned into a plurality of coefficient groups (CGs), the coefficient is included in a CG of the TB, and the write control circuit comprises:
a first transpose processing circuit, arranged to perform a first transpose process to determine a transposed coefficient position of the coefficient in the CG when the transpose flag indicates that the coefficient transpose process is needed;
a second transpose processing circuit, arranged to perform a second transpose process to determine a transposed CG position of the CG in the TB when the transpose flag indicates that the coefficient transpose process is needed; and
a storage position determining circuit, arranged to determine the storage position of the received coefficient according to the transposed coefficient position, wherein the write circuit is further arranged to store the determined transposed CG position into the IS storage device, and the received coefficient is stored into the IS storage device under control of the determined storage position.

10. The coefficient access apparatus of claim 9, wherein the first transpose process and the second transpose process are performed by the first transpose processing circuit and the second transpose processing circuit in a parallel manner.

11. The coefficient access apparatus of claim 8, further comprising:
a read circuit, arranged to directly read coefficients of the TB from the IS storage device to an inverse quantization (IQ) circuit when the transpose flag indicates that the coefficient transpose process is needed.

12. The coefficient access apparatus of claim 8, wherein when the transpose flag indicates that the coefficient transpose process is not needed, the write circuit stores the coefficient into the IS storage device which meets a throughput requirement of an inverse quantization (IQ) circuit; and when the transpose flag indicates that the coefficient transpose process is needed, the write circuit stores the coefficient into the same IS storage device which meets the same throughput requirement of the IQ circuit.

13. The coefficient access method of claim 8, further comprising:
a read circuit, arranged to refer to a mapping table to read the coefficient of the TB from the IS storage device to an inverse quantization (IQ) circuit when the transpose flag indicates that the coefficient transpose process is not needed, and further arranged to refer to the same mapping table to read the coefficient of the TB from the IS storage device to the IQ circuit when the transpose flag indicates that the coefficient transpose process is needed.

14. The coefficient access apparatus of claim 8, wherein the coefficient access apparatus is a part of a second generation Audio Video Coding Standard (AVS2) decoder.

15. A non-transitory machine readable medium having a program code stored therein, wherein when executed by a processor, the program code instructs the processor to perform following steps:
receiving a coefficient generated from an entropy decoding process, wherein the received coefficient is a part of a transform block (TB);
before the received coefficient is stored into an inverse scan (IS) storage device, determining a storage position of the received coefficient according to a transpose flag associated with the TB, wherein the transpose flag indicates whether or not a coefficient transpose process is needed; and
after the storage position is determined, storing the received coefficient into the determined storage position in the IS storage device.

16. The non-transitory machine readable medium of claim 15, wherein the TB is partitioned into a plurality of coefficient groups (CGs), the coefficient is included in a CG of the TB, and determining the storage position of the received coefficient according to the transpose flag comprises:
when the transpose flag indicates that the coefficient transpose process is needed:
performing a first transpose process to determine a transposed coefficient position of the coefficient in the CG; and
determining the storage position of the received coefficient according to the transposed coefficient position; and
the coefficient access method further comprises:
when the transpose flag indicates that the coefficient transpose process is needed,
performing a second transpose process to determine a transposed CG position of the CG in the TB; and
storing the determined transposed CG position into the IS storage device, wherein the received coefficient is stored into the IS storage device under control of the determined storage position.

17. The non-transitory machine readable medium of claim 16, wherein the first transpose process and the second transpose process are performed in a parallel manner.

18. The non-transitory machine readable medium of claim 15, wherein the program code further instructs the processor to perform following steps:
when the transpose flag indicates that the coefficient transpose process is needed, directly reading coefficients of the TB from the IS storage device to an inverse quantization (IQ) process.

19. The non-transitory machine readable medium of claim 15, wherein when the transpose flag indicates that the coefficient transpose process is not needed, the coefficient is stored into the IS storage device which meets a throughput requirement of an inverse quantization (IQ) process; and when the transpose flag indicates that the coefficient transpose process is needed, the coefficient is stored into the same IS storage device which meets the same throughput requirement of the IQ process.

20. The non-transitory machine readable medium of claim 15, wherein the program code further instructs the processor to perform following steps:
when the transpose flag indicates that the coefficient transpose process is not needed, referring to a mapping table to read the coefficient of the TB from the IS storage device to an inverse quantization (IQ) process; and
when the transpose flag indicates that the coefficient transpose process is needed, referring to the same mapping table to read the coefficient of the TB from the IS storage device to the IQ process.

21. The non-transitory machine readable medium of claim 15, wherein the steps are included in a second generation Audio Video Coding Standard (AVS2) decoding process.
